(19) United States
(12) Patent Application Publication
(10) Pub. No.: US 2019/0197637 A1
(43) Pub. Date: Jun. 27, 2019

(54) METHOD AND SYSTEM FOR VALUATION OF A POOL OF REAL ESTATE ASSETS

(71) Applicant: NORTH AMERICAN HOME FINANCE INC., Vancouver (CA)

(72) Inventors: Adam GANT, Victoria (CA); Dimitri MARINAKIS, Duncan (CA); Ashlin RICHARDSON, Victoria (CA)

(21) Appl. No.: 16/225,600

(22) Filed: Dec. 19, 2018

(30) Foreign Application Priority Data
Dec. 19, 2017 (CA) 2989505

(51) Int. Cl. G06Q 50/16; G06Q 30/02

(52) U.S. Cl. CPC G06Q 50/16; G06Q 30/0206; G06Q 30/0205

(57) ABSTRACT

A method and system for evaluation of a pool of real estate assets is disclosed. The method may include a threefold hierarchy of models to encompass geospatiotemporal fluctuations in price for a plurality of assets, at the appropriate comprehensively representative microscopic, mesoscopic, and macroscopic levels of description. The method is particularly useful in enhancing the resilience of modelling and forecasting the price of a pool of real estate assets, owing to the improvements in signal to noise ratio that are gained as a result of data aggregation within suitably small like-with-like groupings of similar real estate units.

### FIELD

There is described a method and System for valuation of a pool of real estate assets.

### BACKGROUND

A common method of real estate valuation is the sales comparison approach. This approach assumes a prudent and rational individual will pay no more for a property than it would cost to purchase a comparable substitute property. The approach recognizes that a typical buyer will compare asking prices and seek to purchase the property that meets his or her wants and needs for the lowest cost. In developing the sales comparison approach, the appraiser attempts to interpret and measure the actions of parties involved in the marketplace, including buyers, sellers, and investors. The sales comparison approach is based primarily on the principle of substitution. An inherent problem with this approach is that real estate units are sold infrequently and their value changes over time.

### SUMMARY

There is provided a method and system that provides to the user price forecasts on the basis of the pool of real estate units, these forecasts being determined according to a sophisticated method of modelling, which involves a threefold hierarchy of models to encompass geospatiotemporal fluctuations in price for a plurality of assets, at the appropriate comprehensively representative microscopic, mesoscopic, and macroscopic levels of description. The method is particularly useful in enhancing the resilience of modelling and forecasting the price of a pool of real estate assets, owing to the improvements in signal to noise ratio that are gained as a result of data aggregation within suitably small like-with-like groupings of similar real estate units.

The method and system provides advantages over systems that forecast solely in consideration of real estate assets on an individual basis and systems that forecasts determined entirely on a collective basis.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a computer flow diagram of the method for valuation of a pool of real estate assets.

FIG. 2 is a computer flow diagram of the microscopic analysis model portion of the computer flow diagram of FIG. 1.

FIG. 3 is a computer flow diagram of the mesoscopic analysis model portion of the computer flow diagram of FIG. 1.

FIG. 4 is a computer flow diagram of the macroscopic analysis model portion of the computer flow diagram of FIG. 1.

FIG. 5 is a first alternative representation of the computer flow diagram of FIG. 1.

FIG. 6 is a second alternative representation of the computer flow diagram of FIG. 1.

FIG. 7 is a schematic diagram of system components for valuation of a pool of real estate assets.

FIG. 8 is a schematic diagram of system components for valuation of a pool of real estate assets grouped by function.

FIG. 9 is a representation of the sample data plotted on a map of Victoria, BC.

FIG. 10 is a scatter plot chart of a model of the Appreciation Function A(t−t′).

FIG. 11 is a scatter plot chart representing the price aspect of data features.

FIG. 12 is a scatter plot chart representing the price aspect of data features used to determine U.

FIG. 13 is a scatter plot representation of the K-means method.

FIG. 14 is a scatter plot representation of the data of FIG. 13 without scaling.

FIG. 15 is a scatter plot representation of the K-means method with scaling.

FIG. 16 is a scatter plot representation of separate plots with respect to the individual variables.

FIG. 17 is a flow diagram of a conceptual feed-forward structural organization of a hierarchical processing pipeline.

FIG. 18 is a schematic diagram of an example of contraction mapping between DAG.

FIG. 19 is a schematic diagram of an algorithm for updating the physical responsively according to increasing and/or decreasing throughput requirements.

### DETAILED DESCRIPTION

Given a representative set of data that includes selling prices and dates of sale for a number of individual real estate units, we want to determine a method of evaluating a set of some number of similar real estate units (a pool). Each single unit has associated with it a number of features which can be used to help infer its value.

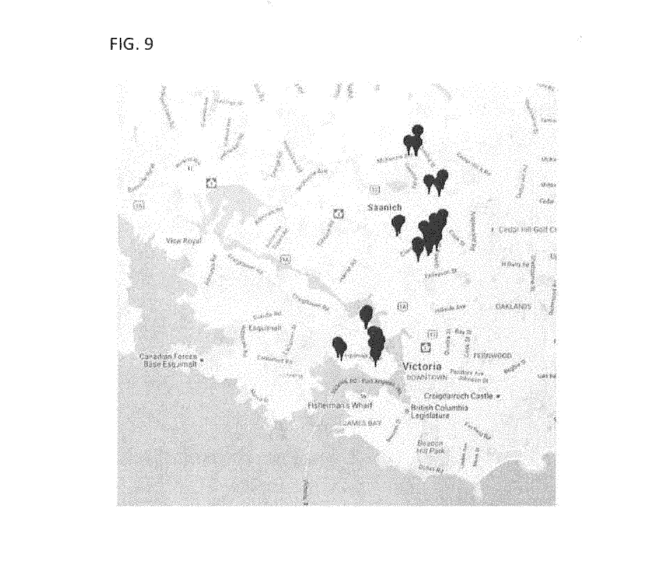

One of the challenges in setting up this problem is that limited “ground truth” is available, i.e., real estate units are sold infrequently and their assessed values change over time. In order to evaluate the potential method we intend to find sets of real estate that were sold at roughly the same time and use the sum of their value as a proxy for the value of that set at the mean time of sale. Sample data provided for this study are plotted in FIG. 9.

Given a data set D with each datum providing a selling price x, a date of sale t, and a set of features f, we seek to evaluate (at time t′>t) a set of test units P (a pool) for which features f′ are available but not prices.

For the data D={d_1, d_2, ·} where d_i=(x_i, t_i, f_i) we are to infer the value of a set P={p_1, p_2, ·} where p_i=(f_i) at time t′ and t′>t_i for all d_i in D. The potential method M takes as input the training data D, the test data set P, and the time t′, and outputs the value v of the pooled real estate in P at time t′, where v=M(D, P, t′).

To assess the performance of the proposed method we will break the CSV format data provided into a number of such pairs of disjoint sets of training data D and test data P, with the intention to evaluate P using a model determined from D. We will refer to the set of such pairs as the cross validation set C={(D_1, P_1), (D_2, P_2), ·}.

Consistent with the above problem definition we require for P that all test data unit sales be temporally coincident and occurring in the future, relative to the training data D. We compute the sum v_gt of the sale value of all units belonging to P and compute the mean of the sale date: t_gt. We assume that v_gt is the correct evaluation of P at time t_gt, which connects the pooled model with the “truth” data. The error associated with the potential method is then the sum of squared error terms, where a squared error term is generated for each pair (D_i, P_i) of training and test data in the cross validation set.

As described above given D, P and t, we aim to infer the value of P at time t. We propose to accomplish this objective according to a two-step process, as follows.

In the first step we will simultaneously learn an appreciation function A and a static unit evaluation function U. This decomposition into a temporally varying component and an atemporal component is based on the idea that the temporality of valuation may be expressed separately from the other features used in valuation that represent the characteristics of a real estate unit at a particular time. We assume that our single unit evaluation model is determined as the product of A and U.

The static unit evaluation function U will predict the price of sale (s) as a function of the features of each real estate unit d at a specific reference time t_r, along with a confidence value (e) associated with that prediction. In other words (s, e)=U(f) where f are features associated with d and s evaluates d at time t_ref.

The appreciation function A predicts the appreciation in value of similar units as a function of the time delta from t_ref. In other words s′=A(f, s, t−t′) where s′ is the predicted sale price of unit d at time t, t′−t gives the that has passed since t_ref, s is the value of the unit at time t_ref, and f are the features associated with d.

### Data Processing and Variable Selection

The original test data set is comprised by 169 records with 19 fields for each record. The initial analysis neglects the first 43 records which lack concrete valuation information from sales. Thus 126 records are considered. To derive a meaningful and comprehensible model we select a subset of the variables, particularly the fields are emphasised that are observed to be substantially related with valuation, whereas we neglected those variables more weakly related with valuation, which we deemed likely to confound modelling of unit valuation. The retained variables are as follows.
Selling price
Date of sale
Total number of finished square feet
Year in which the unit was constructed
Total number of bathrooms
Total number of bedrooms

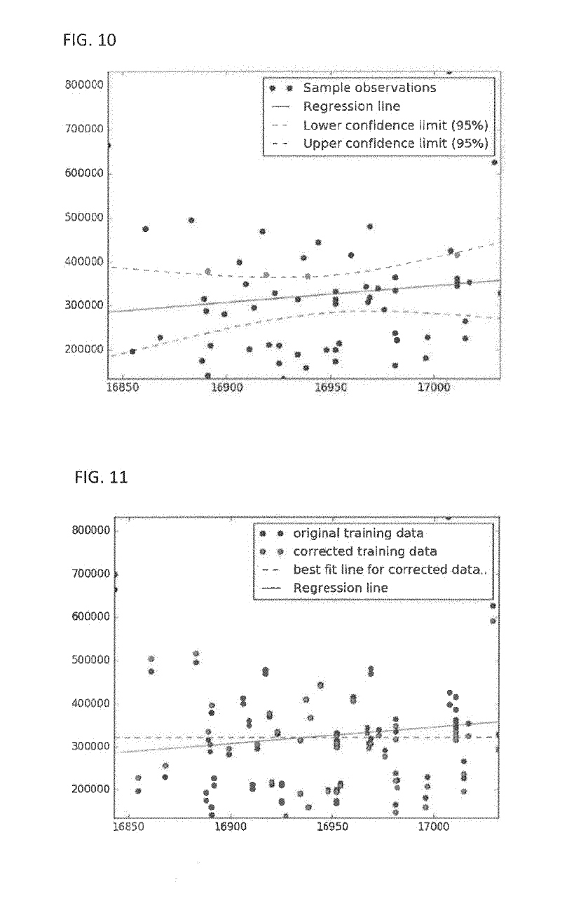

The field “ratio-sell-by-finished-sqft” emphasises the importance of finished square feet in valuation; we do not analyze this variable as other variables represent this information. We preferred to include the finished number of square feet (standard r-value: 0.436) rather than the unfinished number, because the unfinished number did not relate to valuation as clearly (standard r-value: 0.248). From the addresses we produce latitude and longitude which negatively relate with valuation (r-values −0.426 and −0.423 resp.) which reflects higher prices for Vic West units compared to E. Saanich units. Our initial demonstration overlooks spatial coordinates as the data volume is not sufficient for a meaningful comprehension of spatial changes in valuation, yet the proposed approach is intended to include spatial variables. Similarly, valuation doesn't clearly relate with parking availability, days on the market, or rental restrictions. The neglected variables a be restudied in f t re, in light of more data volume as shown in FIG. 10.

### Determining A

Our initial model of the Appreciation Function A(t−t′) is a degree one polynomial with intercept and the appropriate standardised confidence model as shown in FIG. 10. The red line represents appreciation. Sale price observations are in blue. The green dashed line represents the confidence associated with the appreciation model. Having developed a suitable model for appreciation, we can use it to adjust the training features, in order to model a set of training features f′=f−A(t) where the temporal component is considered removed. Next we can determine a model for U in terms of adjusted features f′=T[f]=f−A(t) as shown in FIG. 11.

Determining U′ (f′)

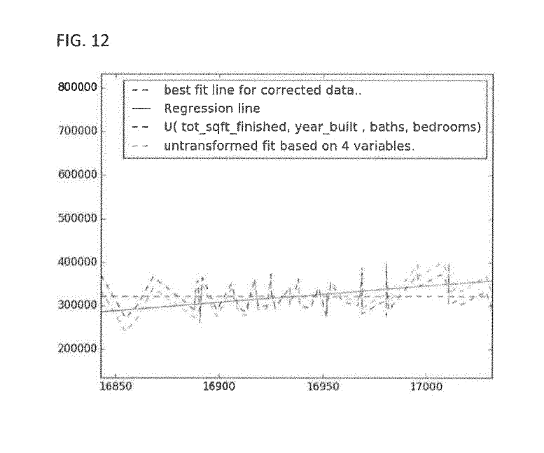

The price aspect of data features is shown in the FIG. 11. The features before adjustment are blue (adjusted features are red). Then we determine U′=U′(f′) as a function of the adjusted features (excluding time and price) by regressing a 1-st order polynomial (without intercept) to the adjusted features. In order to finish determining U(f) (as expressed in terms of the untransformed features) we invert the operation used to adjust the features, and apply that to determine U, as shown in FIG. 12.

### Determining U(f)

Then U(f)=U′(T−1[f′])=U′(f′)+A(t) so our model for U is determined by adding the appreciation function onto the model for adjusted prices. Thus the time-varying component is reintroduced to the model. In both FIG. 11 and FIG. 12, the green line is for the model U, whereas the red line is for U′. FIG. 12 shows U (magenta) and U′ (cyan).

At each quarterly update we employ the current estimate of quarterly appreciation to valuate the pool in light of changes experienced over the last quarter. This new (predicted) assessed value is determined using i) the last estimated evaluation and ii) the confidence associated with i). Also incorporated is the confidence placed on the appreciation function. In the proposed approach, we track the assessed values using generalized state-tracking methodologies (such as the Kalman Filter or the Particle Filter). In the proposed method delimited below we shall track the confidences/uncertainties associated with the evaluation, by registering the variance as an individual variable in the state-tracking machine.

For example, the exact figures depending on the choice and parameters of the generalized state-tracking apparatus: if the assessed pool value at the end of the last quarter was valued at $10 million with a standard deviation of $1 million, and was expected to appreciate in a linear fashion over this period by a value of 0.5 percent with a standard deviation of 0.1 percent, then the new predicted estimate would likely be $10.05 million with a standard deviation of 1.01 million. These quantities represent an idealized example and are for illustration purposes only, and are not intended to accurately represent a full implementation of the proposed approach.

The functions U and A representing the value of a single unit at an arbitrary time as U(f)*A(t) can now be used to evaluate the pool P. Although we did not plot the confidence estimates for U we note that they are generated using the same methodology as they were for A. Thus the confidence figures for U(f)*A(t) are determined by multiplying together the confidences for U(f) and A(t).

To evaluate P we evaluate all units in the pool P at time t and take the sum of the individual valuations as the estimate of the pool value:

$$v ( P ) = {\sum }_{{p}_{i} ∈ P} v ( {p}_{i} )$$

where v=M(D,P,t′). Supposing a linear model this procedure is the same as averaging the features over P followed by applying the model:

$${\sum }_{{p}_{i} ∈ P} v ( {p}_{i} ) = v ( {\sum }_{{p}_{i} ∈ P} {p}_{i} )$$

Since error terms are available we can train multiple models on different training sets, fuse the results by weighted averaging, and determine fused confidence values by integrating (with respect to the same weights) individual confidence values over the set.

We note that in subsequent sections where we flesh out the developments already established into a full algorithm for evaluation of a pool of real estate assets, the idea just established above will be extended by modification for the purpose of i) increasing resilience to noise or confounding factors and ii) adding flexibility to ‘get a grip’ on geospatiotemporally fluctuating quantities, as follows.

The added modification is the establishment of a partitioning of the pool P into a number of disjoint subsets P(̂k). Then, the above expression (*) for the estimate of the pool value v(P) is extended by addition of a subscript (k)

$$v ( {P}^{k} ) = {\sum }_{{p}_{i} ∈ {P}^{k}} v ( {p}_{i} )$$

The latter expression represents the valuation of a “sub-pool” P(̂k). Then for the extended approach the entire pool P is valuated according to the weighted sum:

$$v ( P ) = {\sum }_{k = 1}^{K} {w}_{k} ( {P}_{k} ) \cdot v ( {P}^{k} )$$

where the weights w_k are taken as that fraction of the size |P| of the pool P |P̂k| with respect to the size |P̂k| of the sub-pool P(̂k):

$${w}_{k} ( {P}^{k} ) = \frac{\vert {P}^{k} \vert}{\vert P \vert}$$

We note that the above is one among a plurality of alternatives available for the factors w_k.

Given assessed values and confidences for a pool of real-estate assets we want a system to provide a quarterly valuation assessment, through a quarterly update. The required system inputs are: i) the last quarterly valuation of the pool, and ii) Confidence/uncertainty for the last quarterly valuation of the pool. Optional inputs to the system include: i) independent estimates for any number of individual units in the pool (with confidence/uncertainty) in the form: (time, value, uncertainty), ii) sales information for any number of representative assets including historical values, and iii) estimates of appreciation.

Here we flesh out the framework of elements developed above into an algorithm to track prices of a pool of real estate units, providing quarterly valuation assessment. We will track the evaluation of pools over time, moreover we allow fusion to incorporate incoming information flow relevant to valuation of the pool, such as sale prices or assessment values, and associated uncertainties. We accomplish this with a 3-fold hierarchy of models, as follows.

1. At the low-level we propose applying state tracking methods to track individual property units flexibly to handle incoming data.

2. At the intermediate level, we develop a family of quarterly valuation models {Âj(t),Ûj(f)} fitted to each of a number K of sub-populations P̂j (sub-pools) of like elements within the overall pool. We determine the P̂j by an unsupervised clustering technique (for example, the common K-means approach is one possible such method). Regardless of the choice of unsupervised clustering technique, we shall take the letter K to refer to a user-determined parameter, which could be automatically set to some number that is substantially larger than 1 but substantially less than the number of records, e.g., sqrt(N) or log(N) (where N is the number of records).

3. At the high-level we use the methods and formulae developed in the fused estimates section to aggregate (over the sub-pools, to form an estimate for the entire pool P) the intermediate-level estimates based on the models {Âj(t),Ûj(f)}.

We will describe the process in terms of the general state-tracking filter (of which the Kalman Filter is a well-known example), noting that the proposed approach may be implemented in terms of any state-tracking methods available. For example, the Kalman Filter assumes that the estimated error covariance matrix (a measure of estimated accuracy of the state estimate) follows the multivariate gaussian distribution. Since this assumption may not always be appropriate, our description is reserved in order to include implementation in terms of other techniques such as the Particle Filter.

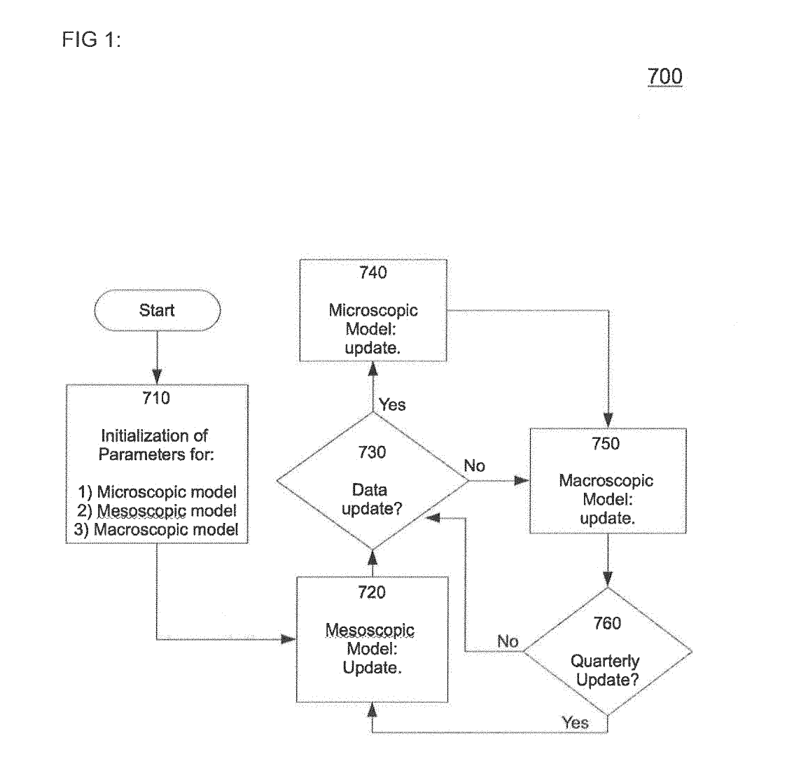

The method establishes a system of models that represent information on a pool of real estate assets at a threefold hierarchical decomposition in terms of three levels of description at which the data are represented. A first embodiment of the threefold decomposition is represented in terms of those applications exposed in FIG. 1 (700) whereby within that diagram the interactions among the system of models at the three levels of description, are unveiled.

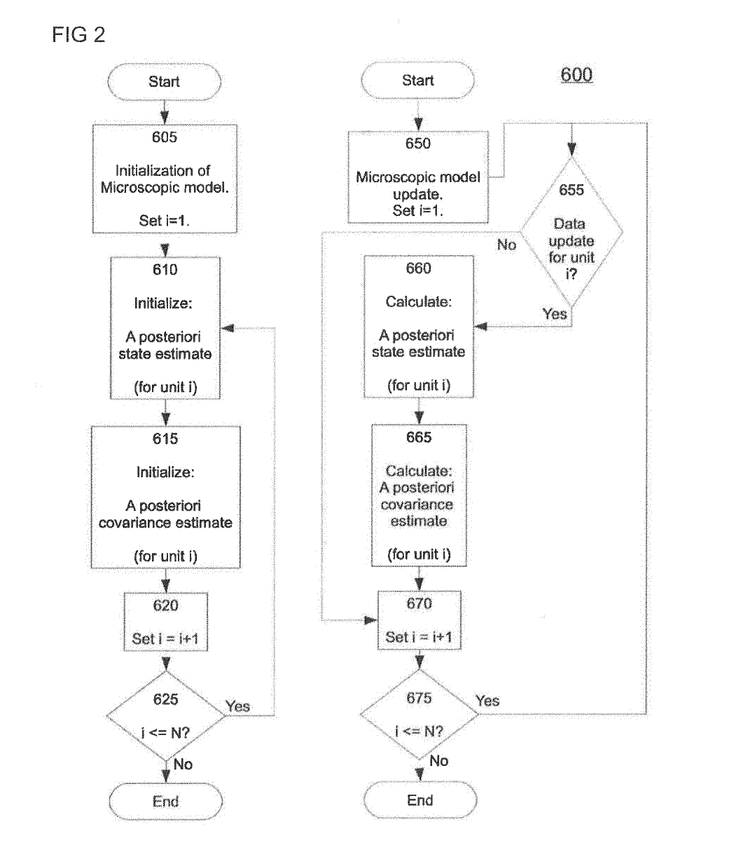

The first or bottom-most level of description within the three-fold hierarchy of levels of description used in the system of modelling of a pool of real estate assets, we shall refer to as the microscopic level of description. An aspect of the inventive method is the representation and tracking of prices and other asset features, whereby assets are represented and tracked on an individual basis. Although multitudinous embodiments of the microscopic representation of real estate units (in terms of their value and other data features available) are possible, a second embodiment is represented according to FIG. 2.

The second or intermediary level of description as the second level among the three-fold hierarchy of levels of description used in the system of modelling of a pool of real estate assets: we shall refer to this as the mesoscopic level of description. An aspect of the inventive method is the representation and tracking of prices and other asset features that are available: at the mesoscopic level, whereby assets are represented and tracked on a collective basis, in terms of a plurality of relatively small like-with-like units that are related in terms of mutual geographic proximity and that are also related in terms of mutual similarity according to all of the different kinds of data features that are available, without discriminatory regard to the specific nature of any particular data feature, since the innovative method is able to manage the multitude of data features available for the assets under consideration without regard to their specific nature.

With all the method and system brought to light here makes no assumption about the nature or number of the data features available to describe a real estate unit or the evolution of the value of a real estate unit. The only assumed requirement of the data features made available for consumption by the system is that each feature be such that it may be adequately represented with sufficient accuracy within a conventional number system, as represented in ordinary computing systems.

The third or top-most level of description belonging to the three-fold hierarchy of levels of description used in the present system, we shall refer to in subsequent developments as the macroscopic level of description. An inventive aspect of the method and system is the representation and tracking of prices and other asset features, in which the prices and other features of real estate units are represented and tracked on a composite level representative of the totality of the population of real estate assets under consideration. That is, the macroscopic level of the modelling exposed within the invention as it is represented here, is concerned with the predicting and forecasting of the totality of price for the real estate units within the pool, as a composite asset.

There is described a method which involves cycling between 3 types of modelling updates, cf boxes 740, 750, and 720 of FIG. 1 (700). With respect to that diagram in FIG. 1. (700) representing the order of communications among the three levels of description considered in the present invention, those skilled in the art will observe that there are a plurality of alternate possible such communications patterns, which, if implemented, would not represent a departure from the scope of the present invention: for example, such patterns involving i) different orderings for the updates within the scope of the same cyclical update scheme ii) structures of communication that do not involve the same cyclic pattern of organization.

With respect to the method disclosed here, it is necessary to initialize the models at each of the three-fold levels of description. Without loss of generality, we assume that the models at the three levels are initialized together (as in box 710 of the diagram in FIG. 1) and the description of the inventive method does not specifically require whether the three components are initialized all at once, or in a particular order. What is important is that each of the three components of the modelling at the different levels of description, are initialized in preparation for their mutual communications, as part of the incremental and continuing temporal updates to the system.

As shown in the diagram in FIG. 1 (700) according to boxes 730 and 760, there are two types of temporal updates to the system. Again we note that a multiplicity of arrangements in terms of communications patterns are possible: in terms of the ordering among the updates corresponding to the various levels of modelling (or the alternative nonlinear possibilities for arrangement) in combination with the plurality of possibilities represented by the options that could be discussed in terms of entry points at which the various temporal updates come into play, we conclude that it is possible to arrive at many other arrangements of the above factors without departing from the scope and spirit of the current invention.

There are two types of temporal updates represented in the specific embodiment of the present invention. The first type of temporal update represented in this embodiment of the present invention as documented here, is an update reflecting the receipt of new data in the generic formats described previously suitable for consumption by this method. While our description does not necessitate the particulars of the data structures or containers used to retain such data updates, a practical possibility to consider for implementation is that any temporal data updates received could be added to the back end of a queue, to allow consumption of new data entries in an orderly fashion. This suggestion is made more to convey a sense of well-orderliness to those responsible for developing concrete implementations of the present invention, because the method and system elucidated here does not in fact strictly require that data be received, or even processed, in a strictly temporal order. The first type of temporal update is represented as box 730 in FIG. 1 (700).

For the sake of simplicity of implementation and for the sake of the simplicity of exposition of the method and system denuded here according to the present invention, we shall assume without loss of generality that new data received by the system are both i) received and processed in a temporal order. However, all of the elements of the present invention as they are embodied here, do not explicitly assume receipt of data elements in a strictly temporal order. Furthermore, due to lack of strict dependence by the elements of the present invention upon a temporal order, concrete embodiments of the inventive method are possible which i) process data in an asynchronous fashion and ii) that process data that are not received in temporal order, i.e., the invention we outline may be implemented in a way that guarantees consumption of data elements that are received out of order or of data elements that a representative of past transactions.

The method is resilient to be inclusive of data representative of past transactions, or transactions received out of order, due to the iterative nature of generalized state tracking methods: generalized state tracking methods are known to produce forecasts dependent upon data representing states corresponding to any number of past temporalities without restriction upon the quantity or temporal ordering of data elements with respect to the order that they are consumed in, by the system. That is, generalized state tracking methods produce estimates or forecasts based on data corresponding to any times up to and including the present time.

The second type of temporal update is a user determined update. Without loss of generality and without constraining the scope of the invention to exclude the possibility of other types of updates, such as irregular updates, we shall assume that the user-determined update is in fact a regular-update that is prescribed to occur once every standard quarter. Again, the suggestion that the update be prescribed at a regular interval, specifically a regular update at quarterly intervals, reflects one embodiment of the inventive method only, were the scope and spirit of the invention are not constrained to the specific interval of the update, or other aspects of the nature of the user determined update. Therefore, for simplicity of communication and the purposes of illustration, we represent the user determined update as a “Quarterly Update”, as depicted in box 760 in FIG. 1 (700).

The present invention in terms of the specific sample embodiment detailed above, where we recognized a plurality of possible variations on the invention of which the method and system are inclusive, then proceeds according to several steps.

1. The valuation models at the microscopic (bottommost) level, the mesoscopic (intermediary) level, and the macroscopic (topmost) are initialized according to the data available at the time of initialization. The data include prices, valuations, and other features, including confidence values in the form of variance information, wherever possible. The initialization is represented in box 710.

2. Somewhat arbitrarily, we indicate that in this embodiment only, the subsequent action carried out by the system is updating the mesoscopic (intermediary-level) model, as in box 720. As mentioned before there are other embodiments that carry out modelling activities of the same nature, but in a different order, or that carry out the same activities in arrangements that are non-ordered.

3. In this embodiment the subsequent activity is checking for receipt of data updates, as in box 730.

4. Conditional upon receipt of data to be consumed by the system, the subsequent activity in this embodiment is updating the microscopic (bottom-most) level description of the model. This reflects that the microscopic level description of modelling is the functional subunit that is responsible for the direct consumption of incoming data records.

5. Box 750 represents the subsequent activity according to this embodiment of the invention, whereby the modelling corresponding to the macroscopic (top-most) level description, is updated. This is the subsequent activity carried out in the present embodiment, regardless whether the previous activity was that of box 730 or that of box 740.

6. Subsequent to the macroscopic model update in box 750, the next activity expressed in this embodiment of the invention, is checking whether a quarterly update is currently due, or, as previously inscribed, an update represented according to some other algorithm or method, is currently due, as in box 760.

7. Supposing that the user determined update (as in any embodiment whatsoever for such an update) is in fact currently due, we deem that, in this embodiment of the invention, the subsequent step will be, once again, as in box 720, updating the mesoscopic model (the model at the intermediary level of description).

8. Supposing that the user determined update is not in fact currently due, the next activity expressed in this embodiment of the invention is, once again, checking whether additional data is available for consumption by the system cf box 730.

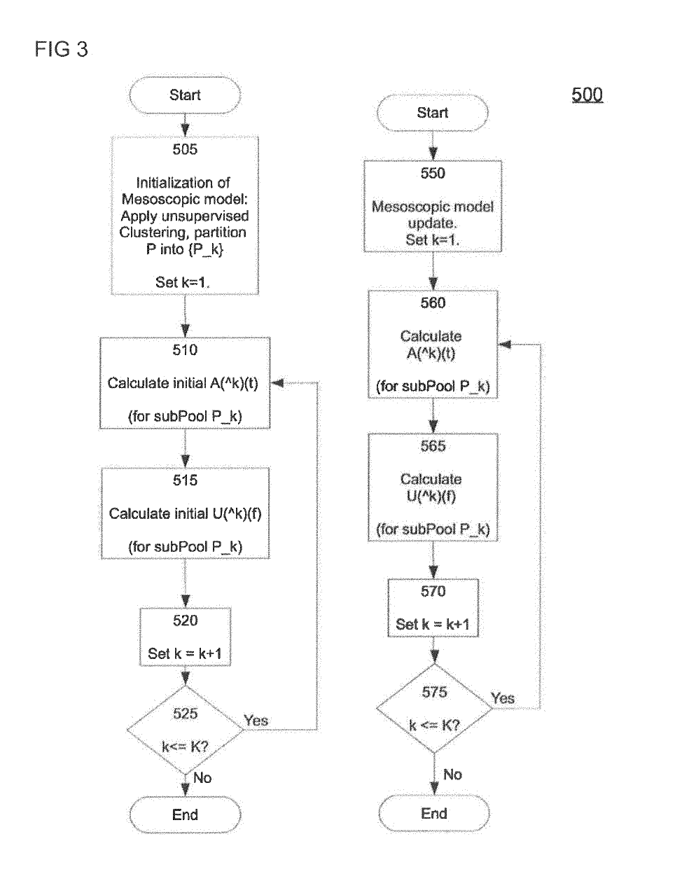

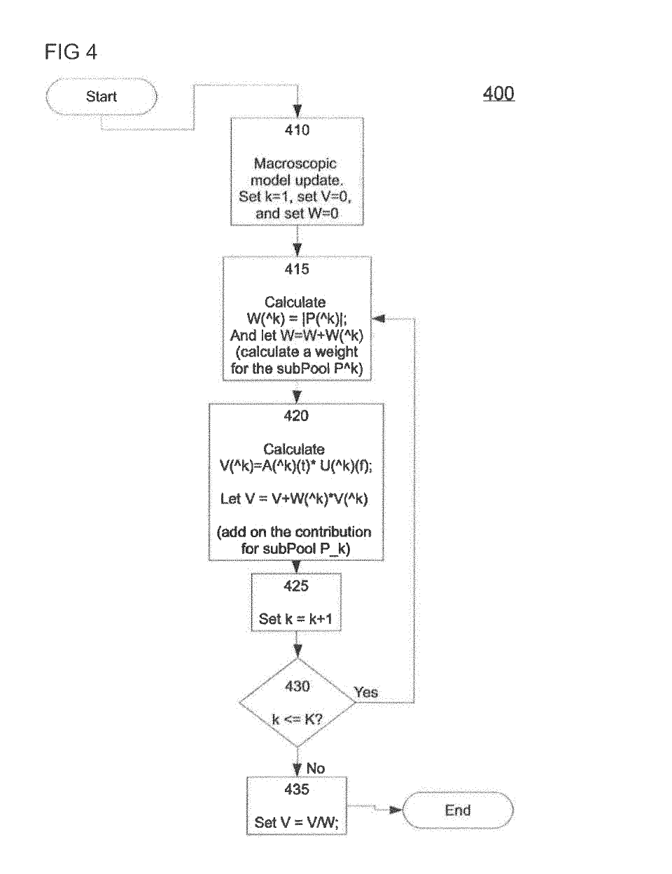

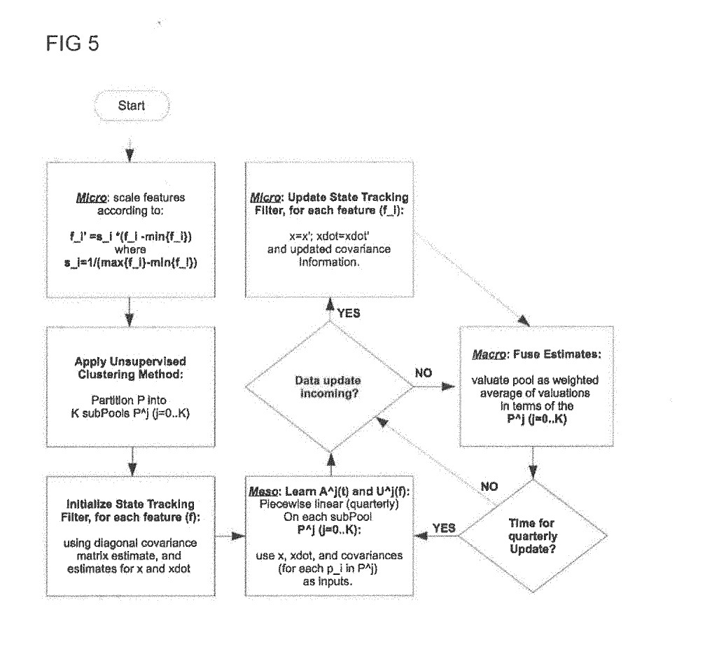

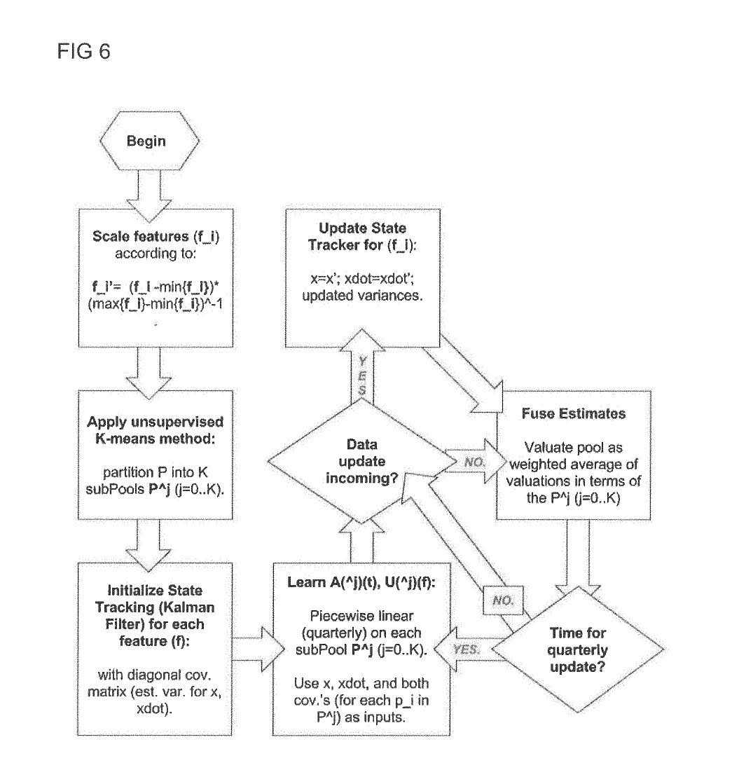

Having exhaustively determined an embodiment of a communications pattern and schedule for initialization and updating, for modelling at each of the three levels of description, we proceed to denude the embodiments of the models at each level of description, as they are implemented according to FIG. 2, FIG. 3, and FIG. 4.

Without loss of generality, we consider a presentation of the current embodiment, in terms of specific details of the initialization procedures represented cf box 710 for the aspects of microscopic, mesoscopic, and macroscopic modelling, respectively.

Other presentations of different embodiments being possible, a presentation of the current embodiment of the initialization procedure for the microscopic aspect of the model is presented according to boxes 605, 610, 615, 620, and 625 of FIG. 2.

Other presentations of different embodiments being possible, a presentation of the current embodiment of the initialization procedure for the mesoscopic aspect of the model is presented according to boxes 505, 510, 515, 520, and 525 of FIG. 3.

The presentations of different embodiments being possible, a presentation of the current embodiment of the initialization procedure for the model is presented according to boxes 410, 415, 420, 425, 430, and 435 of FIG. 4. We note that boxes 410, 415, 420, 425, 430, and 435 of FIG. 4 represent also the updating of the model in the macroscopic aspect, as due to the nature of the specifics of the macroscopic modelling in this embodiment of the Invention, using a different set of activities for the update of the macroscopic model vs the initialization of the macroscopic model is contraindicated for we have not necessitated that special activities be required for updating the macroscopic modelling. In other words, in terms of this embodiment of the macroscopic modelling, we consider initializing that aspect of the model to be functionally equivalent to updating it.

For the microscopic modelling aspect, we treat the initialization of that aspect of the model cf boxes 605, 610, 615, 620, 625 independently from the update portion of the model cf boxes 650, 655, 660, 665, 670, 675 because the update portion does not necessarily rely on special considerations, as is the case for the initialization aspect cf boxes 605, 610, 615, 620, 625. Moreover, the update section has, in an embodiment not restricting the scope of the inventive method, the added ability to neglect modelling updates for model sections whose updates are contraindicated in the event that no new data records are available for consumption by that particular instance of microscopic modelling.

For the microscopic modelling aspect, we consider modelling of asset valuation as a function of time and other informational features available to describe those assets. In this embodiment we consider modelling separately the asset valuation (as dependent on time and informational features) for each of the assets in the real estate pool being considered.

Thus in the current embodiment of the invention, we consider the modelling of asset valuation on an individual asset basis. Notably, our method is not limited to modelling of asset valuation on the basis of individual assets, in fact the method and system in the current embodiment of the invention make use of simultaneous modelling on the individual asset basis, and also on the basis of various groups of assets: the subpools that are represented according to the mesoscopic level of description, and on the basis of the entire collective of assets under consideration (the pool). Valuation of the assets on the collective basis is considered in the mesoscopic model.

The confluence among the microscopic (low-level), mesoscopic (intermediary-level) and macroscopic aspects of modelling is mediated in part by i) the patterns of communication and activity patterns architected in FIG. 1., and ii) the dependencies among the models as denuded within the descriptions of each level of description of the modelling (micro, meso, macro).

Then for both the initialization and update phases for the microscopic modelling aspect, the modelling is performed on a basis of each of the individual assets in the pool P, where i represents the index of a given individual asset. Consequently in the embodiment, in both initialization and update sections, a for-loop is present, representing iteration over the various individual assets.

We have determined, without loss of generality, that the microscopic modelling aspect be determined to represent a generalized state tracking method. In possible embodiments of the approach, the Kalman Filter and the Particle Filter are possible examples of generalized state tracking methods that could be applied to create separate incarnations of the inventive method.

As generalized state tracking methods consider estimates of both the state (which, in this embodiment, refers to the valuation of an asset) and also the covariance (which, in this embodiment, represents a standardised estimate of uncertainty associated with the state variable, which is in this embodiment, the asset value) the i) state estimates and ii) uncertainty estimates are represented as boxes 610 and 615 respectively in the initialization case, and boxes 660 and 665 respectively in the update case. We distinguish the initialization and update cases because special formulae are required to specify initial estimates for the state variables, and the initial estimates for uncertainty.

As in boxes 615 and 665 of FIG. 2,, we describe the standardised uncertainty estimate in one embodiment, as a “covariance”, a specific formalism appropriately representative of uncertainty. We note that other possibilities are available for the choice of measurement to estimate uncertainty other than “covariance”: employing other choices of uncertainty estimate does not constitute departure from the scope of the method and system in the present embodiment.

Similarly to the for-loops in FIG. 2., there are for-loops in FIG. 3. These are indexed by a new variable, k, which represents iteration over a number of subpools, which we shall denote P̂k. This reflects iteration over the instances of “intermediary-level” models.

According to the intermediary level (mesoscopic) modelling, there are K such mesoscopic models. The parameter K is a user determined parameter in this embodiment, although there exist a plurality of methods for automatically choosing K—those skilled in the art will observe that the employment of such methods does not constitute a departure from the inventive method and system as it is represented in the present embodiment.

According to the initialization of the mesoscopic level modelling cf box 505 the overall pool of real estate assets is partitioned into a number of subpools which we denote P̂k. The method of partitioning we take to be an “unsupervised clustering” method, where “unsupervised clustering” methods are among a number of pattern recognition techniques belonging to the body of literature known as “Machine Learning”.

The method of partitioning which, without loss of generality, is assumed to be “unsupervised clustering” (in other embodiments of the invention other partitioning methods could be used) and the well known K-means unsupervised clustering is but one example (not limiting the scope of the invention) of a plurality of such possible clustering methods.

If desired, embodiments of the method and system employing the category of partitioning schemes known in the “Machine Learning” literature as “supervised” techniques, could be used alternatively to the “unsupervised clustering”, without departing from the scope of the inventive method.

Once the partitioning of the pool P of assets is accomplished cf box 505, in either the initialization of update phase of the mesoscopic model, the method carried out by the system in the present embodiment will determine one first order polynomial model (the function A(̂k)(t) for estimation of appreciation (along with an associated uncertainty estimate) for each subpool of real estate assets, P̂k.

In either the initialization of update phase of the mesoscopic model, the method carried out by the system in the present embodiment will determine one first order polynomial model U′(̂k)(f) (as a function of atemporal features of real estate asset data records, those features not including the asset price) for estimation of static valuation (along with an associated uncertainty estimate) for each subpool of real estate assets, P̂k. This is accomplished by regressing ‘transformed’ current valuations against the other (atemporal) features for the pool, where the associated standardised uncertainty is recorded.

As in the exploratory preamble of this document, the current valuations used in

for regression are transformed by an operation represented by correcting the individual valuations available for the elements of the subpool P̂k, by subtraction of the function Âk as in [0037]. Subtraction of Âk from the individual valuations available for the pool results in the ‘transformed’ current valuations used for regression.

The possibility that only a fraction of the elements of a pool (the individual real estate assets belonging to that pool) are updated in terms of the mesoscopic model (Âk, Ûk) for that subpool is already provided for by the embodiments denuded above. However, supposing that updates are available for a fraction of a pool only, and supposing that the implementor of an embodiment of the inventive method and system desires those updates for a fraction of the subpool to be considered to represent suitable updates for the valuation of other elements within the subpool, on the basis that the true valuations for the other elements (for which current updates are not available) should be similar to the updated measurements that are available, on the basis of the nature of the subpool: being a member of a partition into like-with-like groups, the implementor of the method and system could accomplish this variation (without representing a departure from the scope of the invention) using elementary formulae (such as weighted averaging) to determine a forecasted update for those elements for which current updates are not provided, on the basis of those current updates that are provided (for other units within the subpool). We shall deem these possible types of updates “instantaneous forecasts by analogy on the basis of similarity”.

Elementary formulae (such as weighted averaging) may be employed to determine a forecasted update for those elements for which current updates are not provided, on the basis of those current updates which are provided (within the subpool under consideration) the implementor of the method may also prescribe elementary formulae for measures of uncertainty associated with the resulting “instantaneous forecasts by analogy on the basis of similarity”.

An example of elementary formulae for measures of uncertainty associated with the resulting “instantaneous forecasts by analogy on the basis of similarity” could be given by, for example, taking an appropriate weighted average of those uncertainties associated with the values used to determine the “instantaneous forecast by analogy”. Accordingly, it would be necessary to inflate this weighted average according to some factor F̂k which might be determined on the basis of the subpool, as a model for inflation of uncertainty with respect to “instantaneous forecasts by analogy on the basis of similarity”.

The model F̂k to produce an appropriate inflation factor acting upon the estimate of uncertainty associated with the “instantaneous forecast by analogy on the basis of similarity” for a pool P̂k, could easily be determined as a first order polynomial function in terms of the fraction of the pool P̂k to which the “instantaneous forecast by analogy” is extended. Assuming there are |P̂k| units in the subpool P̂k and supposing presently, updates are available for “m” of these units only (and we would like to extend, by analogy, those updates, to estimate present valuations for the other pool elements), then the number of elements to which the “instantaneous forecast by analogy on the basis of similarity” is extended, is |P̂k|−m.

Then we could evolve a model F̂k over time, by modelling the hypothesized inflation factor F̂k in terms of true historical observations of the leave-“m”-out-style variation estimates, according to the deviation of the actual variation estimates with respect to their historical values.

Then, if an estimate for F̂k was used to produce a variation estimate for “instantaneous forecasts by analogy on the basis of similarity” that was too high[low] (according to comparison with “ground truth”) then the inflation factor F̂k would be reduced[increased] accordingly.

The mesoscopic models for the P̂k (each P̂k is a subpool of the overall pool P) are then represented according to the Âk and Ûk (and even the F̂k, supposing an embodiment that implemented the suggestion of valuation by analogy and the associated uncertainty estimation measurements.

Then, the Âk and Ûk representative of the mesoscopic models, represent the consumable factors required for input by the overall macroscopic model (of which there is one, in the present embodiment) as in FIG. 4. Overall valuation for the pool is determined as a simple weighted average as in boxes 415 and 420. The iteration in boxes 415, 420, and 425 represents the iteration over all of the subpools P̂k, where the weighted average (which constitutes the overall result of the method and system in the present embodiment) and the associated uncertainty each receive contributions from each subpool P̂k, as indicated in one pass (of repeated passes) over the activities depicted in boxes 415, 420, and 425.

The macroscopic model, which incorporates contributions on the basis of all of the detailed mesoscopic modelling information corresponding to the different sub-pools, for valuation and associated uncertainty measurement, produces the primary output of the method and system: valuation and associated uncertainty for the real estate portfolio P in its totality.

A further innovative possible aspect of the method is included within the scope of the invention, is as follows: according to parameters for variation of similarity (either determined directly by the user, or determined semi-automatically from the data themselves by procedures such as histogram estimation) with respect to a euclidean distance or other ordinary measurement of comparing the valuation and/or features of one subunit with the features of another subunit, an implementation of this embodiment of the method could include:

1. For a given subpool P̂k, a method for splitting that subpool to produce two or more subpools, in the instance that the variation in the subpool is above the user determined (or semi-automatically determined) threshold.

2. For a given pair of subpools P̂k and P̂j, a method for conjoining the two subpools (producing one resultant pool) in the possible situation that the subpools have become “too close”, in terms of an additional threshold (whether it be user-determined, or semi-automatically determined from the data) whereby, the P̂k and P̂j are merged to form one resultant subpool, in the possible event that the standard set-distance (or other measurement of distance between sets) among P̂k and P̂j falls below the associated threshold (obviously the threshold(s) in 1. and 2. are different entities).

The possible modifications would likely be represented as an insertion of the procedure at the beginning of the update phase, for the mesoscopic modelling. Moreover, with respect to the possible modifications that are included within the scope of the current invention, it would be possible for the thresholds for 1. and 2. evolve dynamically as updates are consumed by the system. Such variation of the method would also be included within the scope of the inventive method, in the present embodiment.

FIG. 12 & FIG. 14—Unsupervised Feature Space Analysis

The K-means method takes a parameter K (the number of clusters) and breaks the data into K groups of like-elements. With K=3 and scaling each field (price_selling, year_built, . . . ) by the formula: the method reveals three patterns in the data, as shown in the

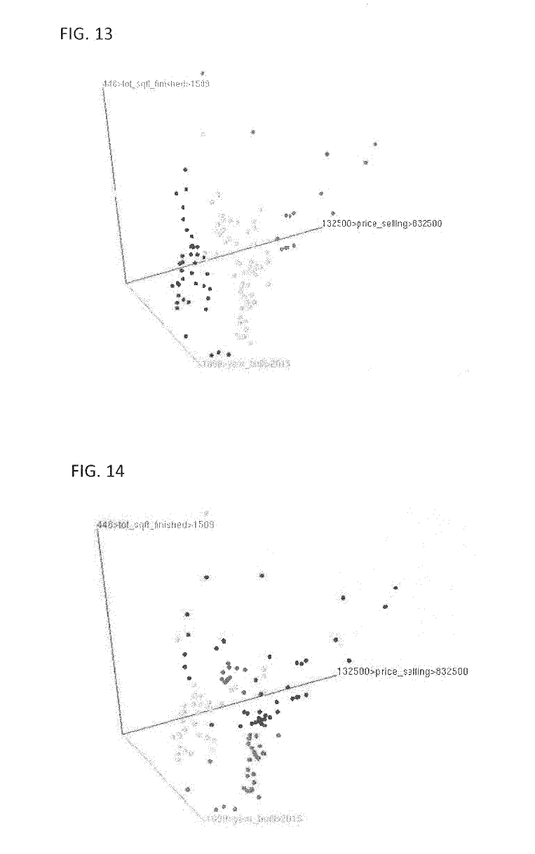

FIG. 13:

(a) a population of older homes built 1973-1993 (blue) that lie in a lower price range and have lower square footage,

(b) to population in the intermediate price range with higher square footage (green), and

(c) a population of recent homes (since 1993) with high square footage (red).

In this example, the data were plotted with respect to the three dimensions: (tot_sqft_finished, year_built, and price_selling).

Scaling adds balance among variables, preventing a variable from dominating. Running the same method without scaling produces less coherent groupings with respect to the same variables (FIG. 14).

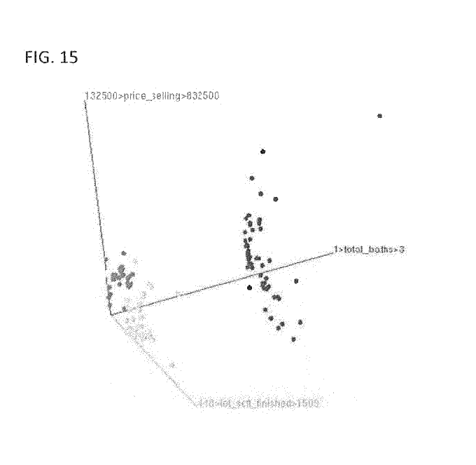

Yet, looking at the same results (K-means with K=3 using unsealed variables) and visualizing with respect to a different trio of variables (price_selling, tot_sqft_finished, total_baths) shows the method did coherently separate properties that had multiple bathrooms (blue) from the other properties. However, as indicated in FIG. 15, scaling the variables helps group the data instances into coherent patterns based on price, square footage, and construction year. Thus, we recommend separately scaling the data fields, for the purpose of organizing the data into groups where we have “like with like”, i.e., for the purposes of the novel element of our proposal, we require to distinguish our observations into groups where an element of a group is as similar as possible in all ways to other elements of the group, whereas without scaling the variables the groups might be overly determined by similarity with respect to one factor (and not others).

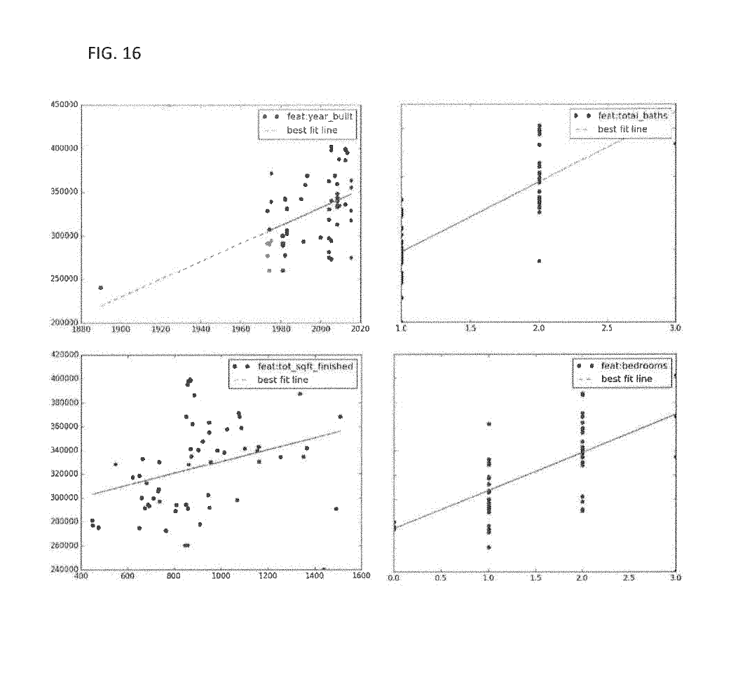

FIG. 16 Separate Plots with Respect to Individual Variables

FIG. 16 separates the plots into individual variables of year built, total bathrooms, total square feet finished and number of bedrooms.

According to the accepted foundations of computer science as proposed by Alan Turing, John Von Neumann and others, conventional computers execute finite but possibly large sets of arithmetic and logical operations. Moreover execution of arbitrary sets of arithmetic and logical operations is comprehensively representative of the capability of computers as they are known for decades, as they are known today, and as they are expected to remain for some time.

As such computers are positively capable of producing the results of any functions that could not be practically accomplished mentally by ordinary persons using pen and paper. Computer technology represents a physical realization of extension of our capacity for ordinary calculations (reading, writing, and arithmetic) thus having a material effect on the operation of the invention above and beyond the purposes of convenience or expedition, making possible the ongoing, responsive execution of a complex modelling system for real estate pool valuation that would otherwise not be humanly possible due to the magnitude of data volume and complexity of the calculations.

Therefore our outline of a physical embodiment of a computer architecture is used to support the claims of the present invention by disclosing specialized knowledge of implementation of said invention to demonstrate the possibility of effectively implementing it.

Because the executional capacity to consume arbitrary sets of instructions is limited by the computer system's storage capacity for instructions and data and the rate of processing instructions we construe an image of an extensible computing system for supporting the present invention beyond particularizing or otherwise limiting the scope of the invention and its embodiments that is scaleable in the sense that it supports hot-pluggable expansion of calculation facilities by adding physical computing modules in response to increased load.

According to the comprehensive representativeness of the theory of DAG (Directed Acyclic Graphs) which emphasizes the network of hereditary relationships (dependencies) among the numerous single computational operations (each distinguished by its distinct inputs and outputs) which together comprise the totality of computational operations that are necessary to represent and implement the present invention at one stage of the computational process, within a physical computing system:

i) beyond a peerless physical computing subunit (such as a microcomputer, mobile computing device, generic desktop computing workstation, or high-performance multiple-core server) multiple physical computing subunits are necessitated insofar as the case where the totality of operations represented by each of the constituent edges comprising the directed acyclic graph of individual computational elements, is sufficiently great in magnitude (quantity of operations) to exceed the physical limitations (in terms of available physical memory and in terms of the rate of execution of physical computing subunits) of the physical computational subunit; [NTD: here an example of the number and type of machines/computer boxes could be helpful in allowing people to visualize what this could look like]

ii) cost benefit analysis directly relating a) physical connectivity of computing subunits with b) the abstract connectionist relations among the individual compute operations organized (as represented formally in terms of DAG) as required by a particular embodiment of the present invention, dictates that an optimal physical connectivity among multiple computing subunits must correspond (specifically formal mathematical language, in the sense of homomorphism) with an abstraction of a DAG.

Informally the content of the mathematical proof ii) is that instances where physical connectivity does not represent an abstraction of the DAG result in instances of computational subunit resources that are under-utilized and/or physical connectivity elements that are over-utilized (bottleneck) resulting in failure to complete required computations determined by an embodiment of the invention (either failure outright or failure to complete required calculations within an acceptable period of time determined by the user).

Without loss of generality, an abstraction of a DAG, or any graph for that matter, can be described as a mapping from that graph to another graph, that is a contraction with respect to the sum of pairwise path-distances, over the set of vertices in the graph, i.e. abstracting a graph lumps connected subgraphs of the DAG representative of the collection of required computations, into categories or buckets, where the resulting graph (“the abstraction”) represents a suitable diagram for the arrangement of hardware network connectivity among physical compute subunits cf FIG. 2.

Without constricting the scope of the invention or the scope of possible embodiments, a possibility for an embodiment of the present invention is the marriage of

i) an initial configuration of physical computational subunits based on algorithmic requirements due to a) known data availability and b) business requirements of model outputs for enhanced business decision making support

ii) an algorithm for adaptive readjustment of physical connectivity (adding or removing physical compute subunits, for example standard inexpensive commodity OTS desktop/server systems, and standard network interconnects such as but not limited to gigabit ethernet interconnects) that adaptively recommends addition or removal of physical compute subunits or interconnects, based on anticipated (forecasted) compute and interconnect resource requirements.

A distinct advantage of the adaptive readjustment approach for physical connectivity is avoiding the application of so-called information-routing algorithms by explicitly determining the relationship between the abstract information processing structures required to embody the invention and the physical embodiment of said processing. Despite the well-established nature of dynamic information-routing algorithms, avoiding them leads to possible advantages in terms of de-risking by explicit determination of a diagram of information flow, instead of relying on black-box information-routing solutions.

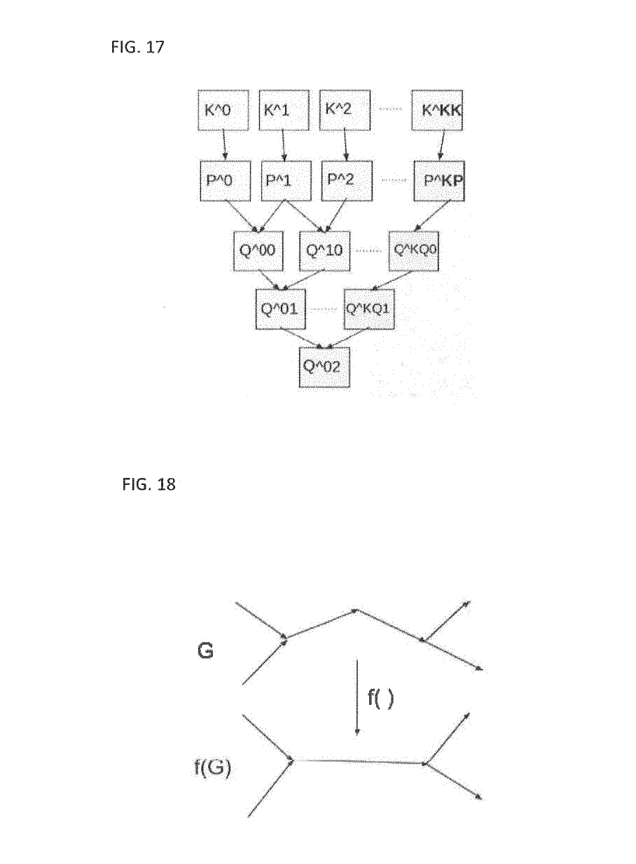

FIG. 17 is a diagram showing a sample static snapshot of physical connectivity of system to reflect a conceptual feed-forward structural organization of hierarchical processing pipeline for one stage of the iterative process as represented by DAG starting with raw input data flows and leading to outputs for enhanced business decision making capabilities. K̂0 to K̂KK are computational subunits responsible for the K-means partitioning. P̂0 to P̂KP are subunits responsible for detailed state tracking for individual units and piecewise learning according to the organization into sub-pools. Finally multiple layers of subunits for hierarchical fusing of estimates are represented by Q̂00 to Q̂KQ0, Q̂01 to Q̂KQ1, and Q̂02 respectively (three layers shown in this example). Depth and width of layers may evolve over time cf FIG. 3.

FIG. 18 is a schematic diagram of an example Table 8 contraction mapping between DAG.

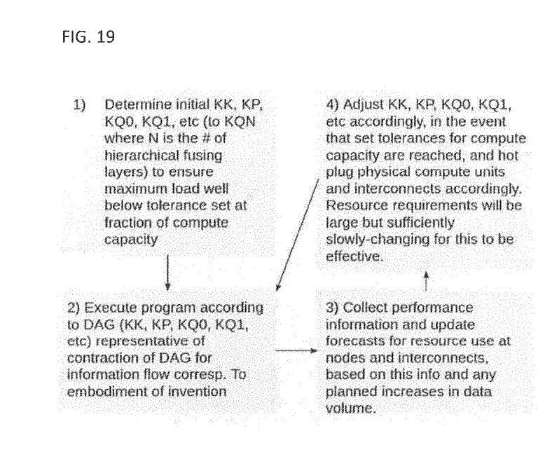

FIG. 19 is a flow diagram of an algorithm for updating the physical responsively according to increasing and/or decreasing throughput requirements. Expected resource utilization (w.r.t to physical compute units and physical compute interconnects) based on historical and or anticipated fixture changes to utilization levels.

For practical applications the data and computational volume will substantial enough to necessitate multiple compute units and multiple layers. Changes in demands to computational volume will reflect the pace of construction and/or business development hence will change slowly enough for feasibility of plug and play hot-swapping of inexpensive commodity units.

With reference now to the Figures, and, in particular, with reference now to FIG. 17, there is depicted a network environment in which the present invention may be implemented. While the present invention is described with reference to one type of network environment, it will be understood that the present invention may be implemented in alternate types of network environments.

First, the network environment incorporates connection to a Transaction History Database Server (THDS) 10. Each region will have data storage and processing on a unique THDS 10 which may include multiple computer servers as well as co-located or cloud based processing and storage, each owned by separate regulatory bodies. Each regional dataset is independently contained and managed within that THDS 10.

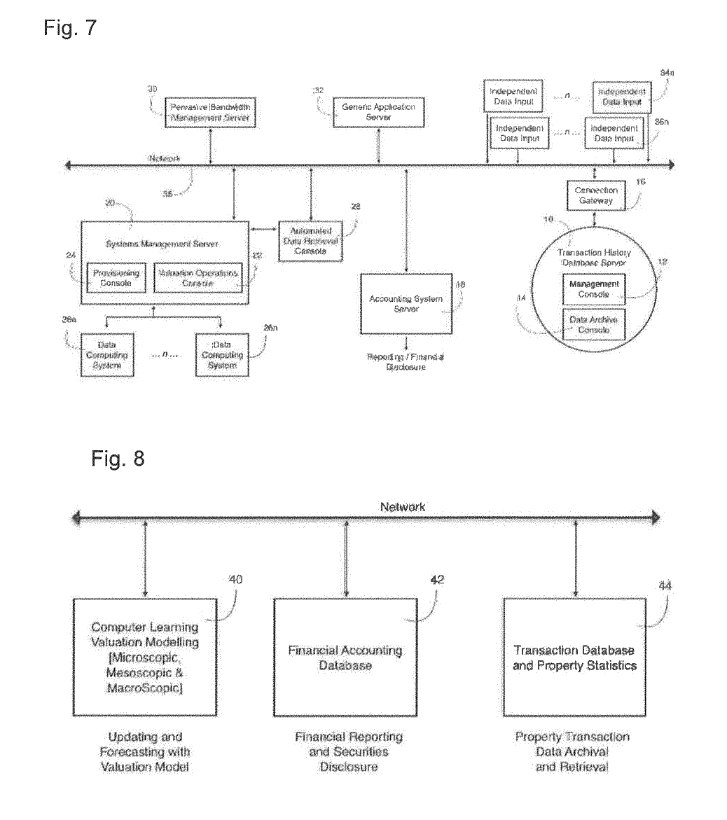

Referring to FIG. 7, where Macroscopic data sets are being examined the length of time taken into account may be larger and the transaction data from the Data Archive Console 14 may be accessed as well as the management console 12. The current year's data as well as ongoing updated transaction data coming in daily can be accessed through the management console 12 and used to continually update the portfolio valuation forecast. The connection gateway 16 allows for secured data transfer of custom constrained data sets which are continually being updated with ongoing transaction activity.

Further, each network within THDS 10 may access server systems external to THDS 10 in the Internet Protocol over the Internet or an Intranet. Such external server systems may include an enterprise server, an Internet service provider, an access service provider, a personal computer, and other computing systems that are accessible via a network. In the present embodiment, transfer of information between THDS 10 and server systems accessible via a network 38 and therefore may require verification and additional security. Network 38 may be preferably considered an external network.

In the present invention, network 38 may comprise a private network, an Intranet, or a public Internet protocol network. Specifically, generic application server 32, pervasive bandwidth management server 30, and systems management server 20 represent server systems that may be accessed by the provisioning console 24 over network 38. Computer devices used for independent data input 34a-34n and 38a-38n may include, but are not limited to desktop devices, tablet devices, wireless devices, pervasive devices equipped with data entry software, a network computer, and other devices enabled for network connected data input. Independent data input 34a-34n and 38a-38n are communicatively connected to THDS 10 through network 38 via wireline, wireless, ISDN, cellular, WIFI and other communication links.

Systems management server 20 manages data processing and computer aided portfolio analysis, valuation synthesis and portfolio value forecasting. In particular, systems management server 20 includes technology that includes a provisioning console 24 for establishing the baseline starting portfolio and a valuation operations console 22 for managing and updating the forecast and total portfolio valuation. The provisioning console 24 preferably accesses the computing power required at any given time to perform the analysis and valuation synthesis computations via a network utilizing a scalable computing system, such as computing systems 26a-26n.

The data set utilized by the valuation operations console may be updated from time to time as required by the automated data retrieval console 28 via accessing the archived and current records held in a THDS 10. In addition, a local copy of a given updated data set in systems management server 20 may be stored for ongoing calculation and valuation variant sensitivity modelling.

The ongoing computing activity of the valuation operations console 22 is performed with computing capacity supported by the data computing system array 26a-26n which will regularly provide portfolio valuation conclusions and forecasts to the accounting system server 18 for reporting requirements. The accounting system server 18 is configured specifically to accept these data transfers from the systems management server 20 and format the inputs for ongoing reporting of asset value movement and trend monitoring.

In particular, to perform accumulated portfolio value synthesis, systems management server 20 may include storage for geographical region specific data set or street/neighbourhood specific information used to interpolate value data points based on relevancy. If a given regionally specific data set is not stored on a systems management server 20, then additional geographical data may be accessed via a network.

Referring now to FIG. 8, there is illustrated a block diagram of the overall data flow and information processing components grouped by function in accordance with the method, system, and program of the present invention.

The computer learning valuation modelling 40 is utilized in order to execute all of the required higher level analysis functions. The data retrieved from the transaction database and property statistics system 44 is processed and stored for ongoing modelling and forecasting. In addition, the output from the modelling and forecasting computing activity is transmitted to the financial accounting database 42 for final use in the securitization process in order to facilitate market trading based on time sensitive financial disclosure and asset value reporting.

In general, based on the nature of the current market transaction activity and incumbent regulatory bodies the invention is required to facilitate timely processing of current data in a precise and accurate way in order to connect the results of that property market data in a way that enables securitization into another kind of financial product for trading in the securities markets within a different regulatory framework. And most importantly, yield a result that is relevant, reliable and accurate in order to be relied upon for transactions involving massively significant financial value.

What is claimed is:

1. A method for valuation of a pool of real estate assets, comprising:
performing a microscopic analysis by tracking prices and asset features of individual real estate assets;
performing an initial mesoscopic analysis by using an unsupervised clustering technique of price and asset features a pool of individual real estate assets;
performing a further mesoscopic analysis by using a targeted clustering technique to divide the pool into sub-pools of individual real estate assets that are related in terms of mutual geographic proximity and mutual similarity of asset features; and
performing a tertiary macroscopic analysis by representing the totality of the price for the real estate assets within each of the sub-pools as a composite asset, with a valuation of the individual real estate assets that make up each sub-pool being computed by taking the totality of the price for each sub-pool divided by the number of individual real estate assets in the sub-pool.

2. The method of claim 1, wherein periodic updates are performed incorporating new data of prices and asset features of individual real estate assets and extending by analogy those updates to estimate present valuations for the composite real estate assets within each of the sub-pools.

3. A system for valuation of a pool of real estate assets, comprising:
a transactional data base of property statistics in which prices and asset features of a pool of individual real estate assets are stored;
a valuation processor which
performs an initial mesoscopic analysis by using an unsupervised clustering technique of price and asset features on the pool of individual real estate assets stored in the transactional data base;
performs a further mesoscopic analysis by using a targeted clustering technique to divide the pool into sub-pool of individual real estate assets that are related in terms of mutual geographic proximity and mutual similarity of asset features; and
performs a tertiary macroscopic analysis by representing the totality of the price for the real estate assets within each of the sub-pools as a composite asset, with a valuation of the individual real estate assets that make up each sub-pool being computed by taking the totality of the price for each sub-pool divided by the number of individual real estate assets in the sub-pool.
